(19) United States
(12) Patent Application Publication
(10) Pub. No.: US 2008/0313947 A1
(43) Pub. Date: Dec. 25, 2008

(54) SCENT DISTRIBUTION SYSTEM, METHOD AND DEVICE

(76) Inventor: George Fachner, Brooklyn, NY (US)

Correspondence Address: ADVANTIA LAW GROUP, 9035 SOUTH 1300 EAST, SUITE 200, SANDY, UT, 84094, US

(21) Appl. No.: 12/141,761

(22) Filed: Jun. 18, 2008

Related U.S. Application Data
(60) Provisional application No. 60/945,270, filed on Jun. 20, 2007.

(51) Int. Cl. A01M 31/00; F41B 11/00

(52) U.S. Cl. 43/1; 124/56

(57) ABSTRACT

A scent distribution system, method, and device for distributing lure. There is a gun, including: a barrel portion, having a chamber disposed therein; and a handle portion, coupled to the barrel portion and extending substantially orthogonal therefrom; and a first projectile including a luring scent configured to lure prey, disposed within the chamber of the barrel portion. The handle portion comprises a storage compartment disposed within the handle portion. There is a second scented projectile, disposed in the storage compartment. The storage compartment is air-tight. The first projectile comprises an absorbent portion including a fluid scent disposed therein. The first projectile includes a flexible portion disposed at a back-end of the projectile and configured to provide air-flow resistance when disposed within the chamber, thereby permitting the projectile to be launched by an imbalance in air pressure.

This Application is a Non-provisional application which claims the benefit, under 35 U.S.C. § 119, of U.S. Provisional Application No. 60/945,270, filed on Jun. 20, 2007.

### BACKGROUND OF THE INVENTION

1. Field of the Invention

The present invention relates to scent distribution systems, methods and devices, specifically, to scent distribution systems, methods, and devices for distributing lure to prey during hunting.

2. Description of the Related Art

Liquid animal lures, which rely on particular scents to attract particular animals, are often used by hunters to attract prey and to mask their own scents. By proper and clever use of odors to imitate certain natural smells, a person may, at times, be very close indeed to certain animals which are otherwise difficult to approach without the person ever being detected by smell. And the person may, by the use of odors, attract a large number of animals to a location, where the person may be. These methods are often particularly useful for hunting the larger species of game where it is necessary to come into close proximity to the game.

For example, hunters often use a type of liquid lure for luring buck which gives off the odor of an estrus doe. This liquid is commonly used as a lure by saturating a wad of cotton with the liquid, and by carrying the wad of cotton to a desired area or location for attraction. Additionally, odor producing products for hunting are commonly sold as free flowing liquids in a plastic bottle with a dispensing nozzle built into it.

Frequently, the hunter applies a trail of the lure leading to his blind or place of hiding. Liquid lures are often expensive and difficult to distribute. The distribution of liquid lures is often messy and when spilled on clothing may stain the clothing and give-off an odor which is offensive to the hunter. Because of the high cost, most hunters are very careful to avoid being overly generous with applications of the lure. Also, since it is important to leave a generally continuous trail of scent, care must be taken to avoid substantial gaps in the scent trail during the application procedure.

However, maintaining a desirable application of lure while walking through the woods, or along a trail, can be a tedious chore for the hunter. Moreover, it is often difficult to distribute lure without alarming the intended prey. Some improvements have been made in the field. Examples include, but are not limited to, the references described below, which references are incorporated by reference herein:

U.S. Pat. No. 6,101,754, issued to Knapick, discloses a lure that is shown for attracting game and the like. It is taken up when not in use by mechanical or automatic devices and stored in a substantially tight area.

U.S. Pat. No. 6,712,286, issued to Baxter et al., discloses a system for dispersing a scent and marking a trail for hunting and other outdoor endeavors. There is a self-fastening scent dispenser and marker to a preselected structure as well as the person and apparel of a user. The apparatus includes a camouflage cover so that the apparatus can easily be concealed when in use. A reflector can also be included, however, so that the apparatus can be located in the dark using a generated light beam, while also protecting the user by identifying the user to other hunters in the area. Methods are also provided to permit a hunter or hiker to readily attach the self-fastening scent dispenser and trail marker as the user moves along a trail during the hunt, hike, or other outdoor excursion.

U.S. Pat. No. 5,987,800, issued to Regan, discloses a scented trail making device including a spring-biased alligator clamp. A length of rope is secured to the alligator clamp. A retention portion is secure to the length of rope. A piece of cloth is slidably disposed within the retention portion. A scented liquid soaks the piece of cloth. The clamp is secured to a pant leg of a hunter whereby the soaked piece of cloth will drag along a ground area to leave a scented trail that will attract deer to a hunting site.

U.S. Pat. No. 4,609,245, issued to Sakschek, discloses a novel package for dispensing odors such as naturally occurring odors, commonly for the purpose of either masking from wild animals the odor of a human in the vicinity, or for the purpose of attracting wild animals. The package includes a receptacle, a reservoir in the receptacle, and an odor producing liquid in the reservoir. A dispensing conduit extends from the reservoir to a dispensing tip. The microporous construction of the conduit is capable of preferentially absorbing the liquid from the reservoir and conducting it to the tip where it is dispensed by evaporation, or by a touching or rubbing action. A cap is used for closing the package by emplacement over the tip. It is also used for hanging the dispenser. One method of dispensing includes selecting a location, opening the dispenser by removing the cap, and placing the dispensing package in the selected location. Another preferred method includes rubbing the tip on an object, thereby to leave a thin film of the odor producing liquid on the object.

U.S. Pat. No. 4,773,177, issued to Gray II et al., discloses an animal lure liquid dispenser consisting of a vial of liquid animal lure in open communication with a microdrip chamber. The microdrip chamber communicates with a dispensing tube, which dispenses the lure a drop at a time onto the floor of the forest. The device contains a flow-control device for regulating the flow of lure through the apparatus. The apparatus is designed to be used in simulating, or with an animal “scrape” in the forest. The device is suspended from the branch of a tree, so that the lure drips at a regulated flow onto the real or simulated “scrape.”

U.S. Pat. No. 5,369,903, issued to Cox, discloses a deer lure and method whereby urine from a domestic goat is utilized. An absorbent cotton is saturated with undiluted urine and is suspended in a substantially triangular type area configuration whereby the sides of the triangle are each about twenty yards in length with absorbers at the points of the triangle. Additional urine is placed on the ground in the center of the triangle. Both buck and doe are attracted as the scent producing urine as it permeates the atmosphere. A method of collecting urine from domestic goats and apparatus is also provided utilizing a mesh covered pan.

The inventions heretofore known suffer from a number of disadvantages, which include: being difficult to use, ineffective, awkward in distribution, and/or expensive; and/or causing scent spilling.

Accordingly, there exists a need for a scent distribution system, method and device that solves one or more of the problems herein described or that may come to the attention of one skilled in the art after becoming familiar with this specification.

### SUMMARY OF THE INVENTION

The present invention has been developed in response to the present state of the art, and in particular, in response to the problems and needs in the art that have not yet been fully solved by currently available scent distribution systems, methods and devices. Accordingly, the present invention has been developed to provide a scent distribution system, method and device for distributing lure.

In one embodiment of the invention, there is a scent distribution device for distributing lure, which may include: a gun, which may be configured to propel a projectile, including: a barrel portion, having a chamber which may be disposed therein; and/or a handle portion, coupled to the barrel portion and/or extending substantially orthogonal therefrom; and/or a first projectile including a luring scent configured to lure prey, disposed within the chamber of the barrel portion. The handle portion may further comprise a storage compartment which may be disposed within the handle portion, and/or may be configured to store projectiles.

In another embodiment of the invention, the scent distribution device may further include a second scented projectile, which may be disposed in the storage compartment, and/or may be configured to lure prey. The storage compartment may be air-tight, and/or may thereby permit long-term storage of scented projectiles therein. The first projectile may comprise an absorbent portion, which may include a fluid scent which may be disposed therein. The first projectile may include a flexible portion which may be disposed at a back-end of the projectile and/or which may be configured to provide air-flow resistance when disposed within the chamber, and/or may thereby permit the projectile to be launched by an imbalance in air pressure.

In still another embodiment of the invention, the first projectile may be a cotton swab. In yet another embodiment of the invention, the gun may be camouflage. In still yet another embodiment of the invention, the gun may be plastic.

In even still another embodiment of the invention there may be a scent distribution method for distributing lure, which may include the steps of: arriving at a first area; and/or distributing a scent to a second area from the first area by shooting a scented projectile thereto. The scent may distributed to the second area from the first area by shooting the scented projectile thereto with a gun which may be disposed in the first area.

In an additional embodiment of the invention, the method may further include the steps of: hunting from the first area; distributing the scent to a third area from the first area; and/or distributing the scent to a fourth area from the first area. An area between the first area, the second area, the third area, and/or the fourth area may be substantially conical in shape, and/or the first area may be an apex. In yet an additional embodiment of the invention, the method may further include the steps of: distributing the scent to a fifth area; redistributing the scent to a second area; redistributing the scent to a third area; and/or redistributing the scent to a fourth area.

In still an additional embodiment of the invention, there may be a scent distribution system for distributing lure, which may include: a gun, that may be configured to shoot, which may be disposed in a first area, and/or which may include: a barrel portion, having a chamber which may be disposed therein; and/or a handle portion, coupled to the barrel portion and/or extending substantially orthogonal therefrom; and/or a first projectile including a luring scent, which may be configured to lure prey, that may be disposed in a second area, and/or removably coupleable to the chamber of the barrel portion. In still yet an additional embodiment of the invention, the system may further include a second projectile including a luring scent, which may be configured to lure prey, that may be disposed in a third area, and/or removably coupleable to the chamber of the barrel portion. The first and/or second projectiles may each include an absorbent portion. The first and/or second projectiles may each be a cotton swab.

Reference throughout this specification to features, advantages, or similar language does not imply that all of the features and advantages that may be realized with the present invention should be, or are, in any single embodiment of the invention. Rather, language referring to the features and advantages is understood to mean that a specific feature, advantage, or characteristic described in connection with an embodiment is included in at least one embodiment of the present invention. Thus, discussion of the features, advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational view of a scent distribution device, according to one embodiment of the invention;

FIG. 2 is a front perspective exploded view of a scent distribution device, according to one embodiment of the invention;

FIG. 3 is a side elevational partially broken view of a scent distribution device, according to one embodiment of the invention;

FIGS. 4A-4D are front elevational views of various embodiments of a first projectile of the invention;

FIG. 5 is a flowchart of a scent distribution method, according to one embodiment of the invention;

FIG. 6 is a flowchart of a scent distribution method, according to one embodiment of the invention;

FIG. 7 illustrates a scent distribution area, according to one embodiment of the invention; and

FIG. 8 illustrates a block diagram of a scent distribution system, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole, or in part, one with another as the claims and/or art may direct, either directly or indirectly, implicitly or explicitly.

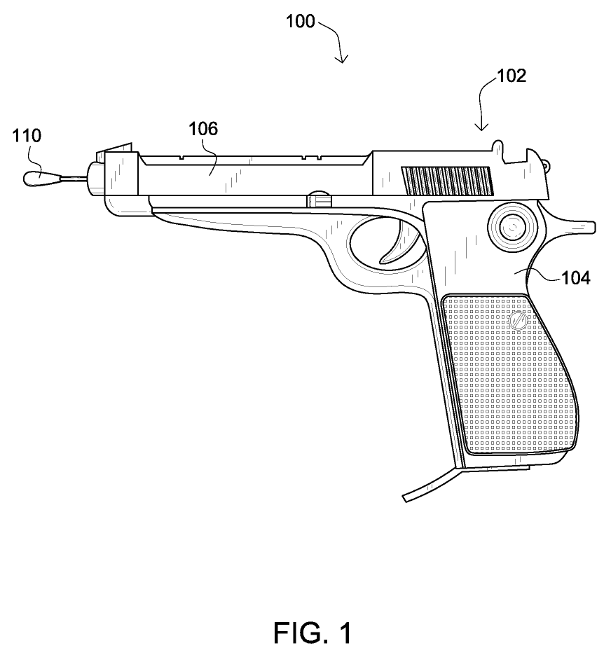

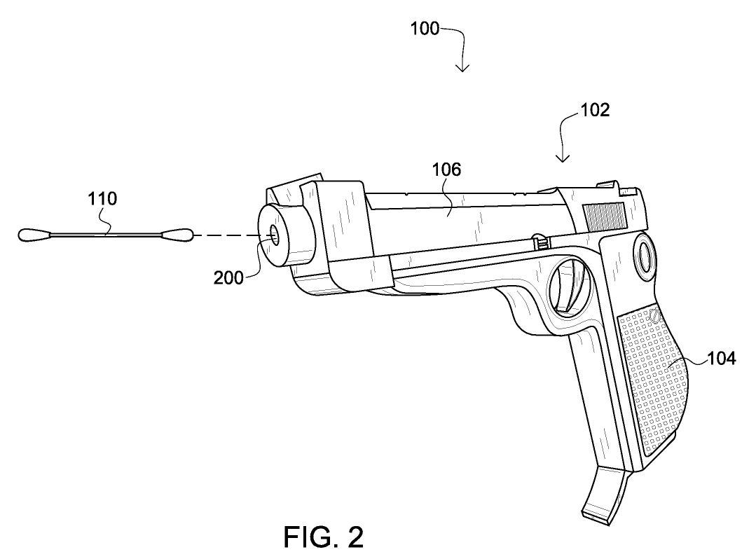

FIGS. 1 and 2 illustrate a scent distribution device 100 for distributing lure. As shown, the scent distribution device 100 is a gun 102 with a barrel portion 106 and a handle portion 104. The handle portion 104 extends substantially orthogonal from the barrel portion 106 so that the gun 102 may be gripped while being configured to propel a projectile. As a result, one skilled in the art would understand that the gun 102 may be such as the Spring Type Projectile Projecting Device of U.S. Pat. No. 3,968,784, issued to Miller, which is incorporated by reference herein. Furthermore, one skilled in the art would appreciate that the gun 102 may be comprised of a light-weight material, such as plastic.

Also illustrated in FIGS. 1 and 2, there is a first projectile 110 disposed within a chamber 200 of the barrel portion 106. Accordingly, one skilled in the art would understand that the gun 102 and first projectile 110 may be such as the Dart Gun and Dart Therefore of U.S. Pat. No. 4,212,285, issued to Cagan et al., which is incorporated by reference herein. Additionally, the first projectile 110 includes a luring scent configured to lure prey. There may be a fluid containing or holding portion such as, but not limited to textile matrix, a hollow sphere, and the like. For instance, one skilled in the art would appreciate that the first projectile 110 may be comprised of a material which includes the scent of buck urine or urine of an estrus doe, such as the game attracting fluid of the Game Luring Scent Dispensing Kit of U.S. Pat. No. 5,060,411, issued to Uhlman, which is incorporated by reference herein.

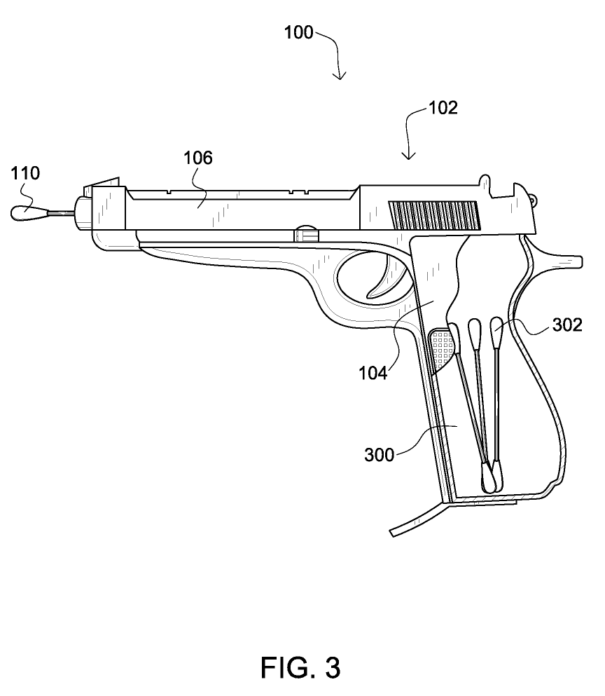

In FIG. 3, there is illustrated a scent distribution device 100 with a handle portion 104 that is a storage compartment 300 configured to store projectiles. As shown, there is a second scented projectile 302 disposed in the storage compartment 300. Similarly, the second scented projectile 302 is configured to lure prey and may also include the game attracting fluid of the Game Luring Scent Dispensing Kit of U.S. Pat. No. 5,060,411, issued to Uhlman, which is incorporated by reference herein. Moreover, the storage compartment 300 is illustrated as air-tight. Advantageously, the storage compartment 300 provides for convenient and long-term storage of scented projectiles 110, 302 therein.

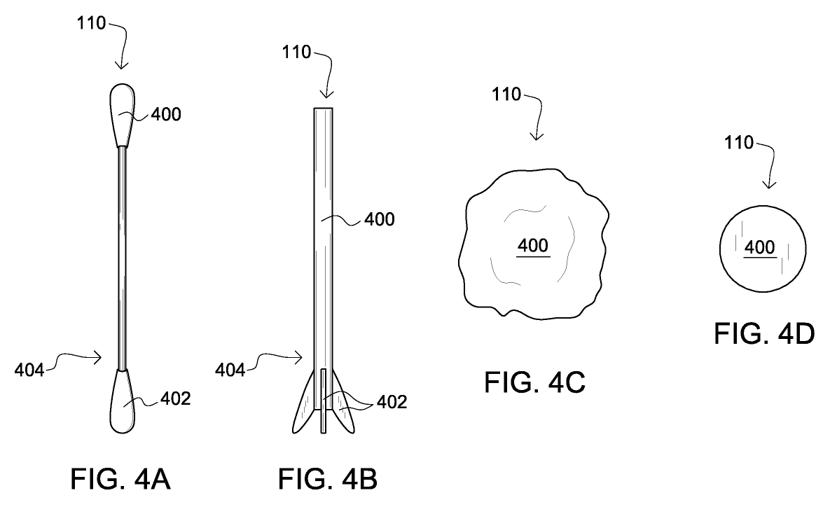

FIGS. 4A-4D illustrate various embodiments of the first projectile 110. As illustrated, the first projectile 110 may include an absorbent portion 400 for absorbing a fluid scent. For example, the first projectile 110 is illustrated in FIG. 4A to be a cotton swab. In FIG. 4B, the first projectile 110 is illustrated to be a foam dart. In FIG. 4C, the first projectile is shown as a cotton ball. And in FIG. 4D, the first projectile is shown to be a balloon-type object, such as a paintball. For these reasons, one skilled in the art would understand that the absorbent portion 400 may be comprised of an absorbent material, such as, but not limited to cotton, foam, and/or tissue paper. Further, one skilled in the art would understand that the first projectile 110 may include a flexible portion 402 disposed at a back-end 404 of the projectile 110 for providing air-flow resistance when disposed within the chamber 200, thereby beneficially providing the projectile to be launched by an imbalance of air pressure.

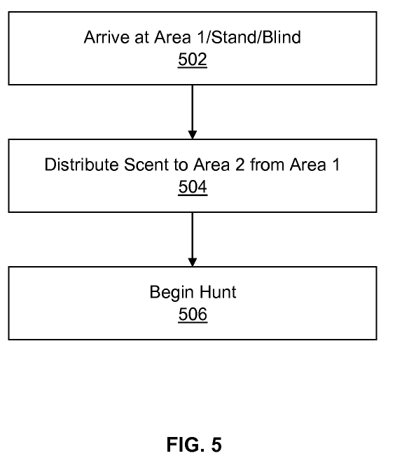

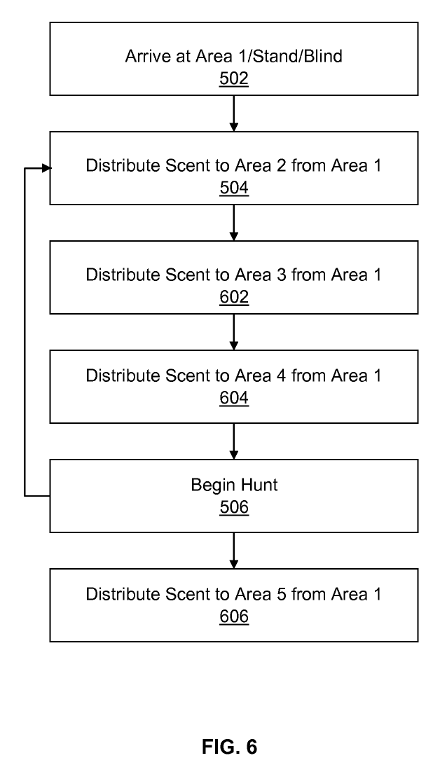

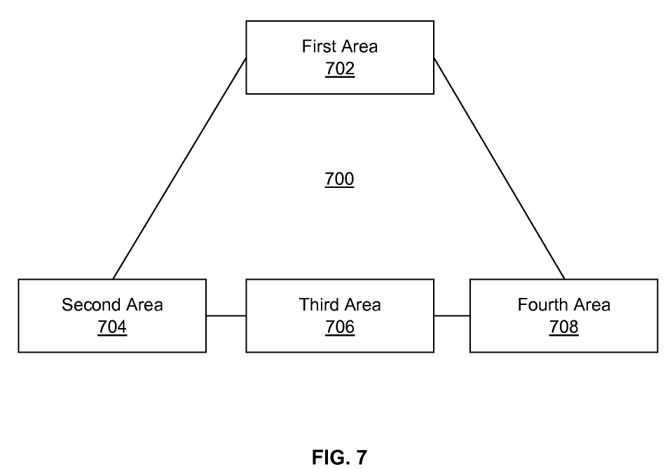

FIGS. 5, 6, and 7 illustrate a scent distribution method for distributing lure. In one embodiment of the invention, a hunter arrives at a first area 502, which may be a stand or blind for hunting animals. Next, the hunter distributes scent, or lure, to a second area from the first area 504. For example, the hunter may distribute scent to the second area from the first area by shooting a scented projectile to the second area with a gun in the first area. After distributing scent to the second area 504, the hunter begins to hunt 506.

In another embodiment of the invention, a hunter arrives at a first area 502. Then, the hunter distributes scent to: a second area from the first area 504; a third area from the first area 602; and a fourth area from the first area 604, thereby forming an area 700 between the first area 702, the second area 704, the third area, and the fourth area 708 which is substantially conical in shape. Advantageously, the area 700 is substantially conical so that luring scent may be fanned out from the hunter with the hunter disposed in the first area 702, or apex, thereby masking the hunter's odor while simultaneously drawing in prey. Next, the hunter may begin to hunt 506.

Once the hunter has begun to hunt 506, the hunter may redistribute scent to the second, third, and fourth areas 504, 602, and 604. Advantageously, the hunter may redistribute scent and/or strengthen scent in areas 504, 602, and 604 to adjust for environmental factors such as wind and rain, as well as lapse of time. Additionally, the hunter may lure in prey from a different direction by distributing scent to a fifth area from the first area 606. Beneficially, the hunter may adjust scent distribution according to wind direction. Also advantageous, the hunter may efficiently and effectively distribute scent to a plethora of areas without having to leave his or her stand or blind in the first area. Moreover, the hunter may safely distribute scent without being mistaken for prey him or herself by other hunters, thereby reducing the number of hunting accidents.

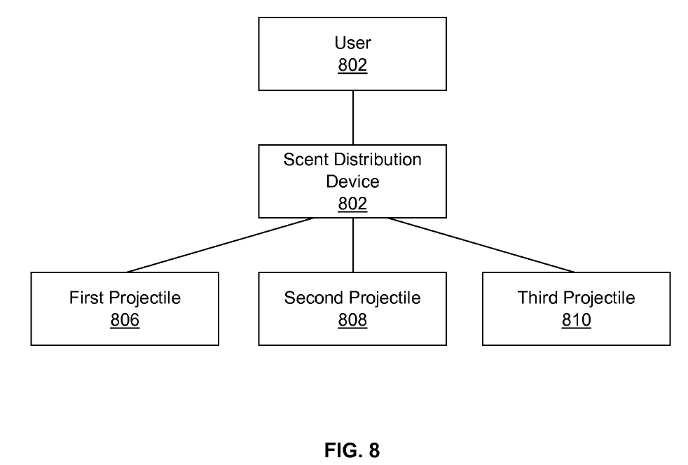

Finally, FIG. 8 illustrates a scent distribution system for distributing lure. As shown, there is a user 802, such as a hunter, who is in communication with a distribution device 804, such as the gun 102 of FIG. 1. Accordingly, the hunter may be holding the distribution device 804, or he or she may be near the distribution device 804 for projecting scented objects from the distribution device 804 in a first area.

The distribution device 804 is also shown in communication with a first projectile 806, a second projectile 808, and a third projectile 810, in second, third, and fourth areas, respectively. For example, the projectiles 806, 808, 810 may be such as the projectiles 110 and 302 of FIGS. 1 and 3, respectively. Accordingly, the projectiles 806, 808, 810 include a scent and are removably coupleable to the distribution device 804 for projecting to areas separate from the first area, thereby creating a mask around the hunter's scent and luring prey into the first area.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate a colorless gun 102, one skilled in the art would understand that the gun 102 may include a color. For example, the gun 102 may include a color, such as, but not limited to: hunter's orange, for safety; and/or camouflage, for concealment.

Additionally, although the figures illustrate the scent distribution device 100 as a gun 102, it is understood that the scent distribution device 100 may be any device understood in the art for projecting scented projectiles. For example, the scent distribution device 100 may be an air propelled gun, a bow or a slingshot.

It is also envisioned that the projectiles 110, 302 may have any size and/or shape, and may be comprised of any material, appreciated in the art for carrying scent. For example, the projectiles 110, 302 may be such as, but not limited to: cotton swabs, foam darts, cotton balls, foam balls, paintballs, and liquid-filled rubber balloons which burst upon contact with their environment. Similarly, it is understood that the projectiles 110, 302 may be comprised of a bio-degradable material, such as, but not limited to: paper and/or other organic material.

Further, it is understood the projectiles 110, 302 may be scented prior to purchase by a hunter, or the projectiles may be scented by a hunter immersing the projectiles 110, 302 into a lure of his or her choosing. Accordingly, it is envisioned that the scent distribution device, method, and system, may include a container of liquid lure for preparing projectiles.

It is expected that there could be numerous variations of the design of this invention. For instance, the gun 102 and/or projectiles 110 and 302 may have any size and/or shape appreciated in the art for carrying out the invention.

Finally, it is envisioned that the components of the scent distribution device 100 may be constructed of a variety of materials. For example, the scent distribution device 100 may be comprised of materials such as, but not limited to: plastic, rubber, metal, wood, cotton, foam, and/or rubber.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the functions, features, structures, and/or methods described herein.

What is claimed is:

1. A scent distribution device for distributing lure, comprising:
a gun, configured to propel a projectile, including:
a barrel portion, having a chamber disposed therein; and
a handle portion, coupled to the barrel portion and extending substantially orthogonal therefrom; and
a first projectile including a fluid holding portion including a luring scent configured to lure prey, disposed within the chamber of the barrel portion.

2. The scent distribution device of claim 1, wherein the handle portion further comprises a storage compartment disposed within the handle portion, and configured to store projectiles.

3. The scent distribution device of claim 2, further comprising a second scented projectile, disposed in the storage compartment, and configured to lure prey.

4. The scent distribution device of claim 2, wherein the storage compartment is air-tight, thereby permitting long-term storage of scented projectiles therein.

5. The scent distribution device of claim 1, wherein the first projectile comprises an absorbent portion including a fluid scent disposed therein.

6. The scent distribution device of claim 5, wherein the first projectile includes a flexible portion disposed at a back-end of the projectile and configured to provide air-flow resistance when disposed within the chamber, thereby permitting the projectile to be launched by an imbalance in air pressure.

7. The scent distribution device of claim 8, wherein the first projectile is a cotton swab.

8. The scent distribution device of claim 1, wherein the gun comprises camouflage.

9. The scent distribution device of claim 1, wherein the gun comprises plastic.

10. A scent distribution method for distributing lure, comprising the steps of:
arriving at a first area; and
distributing a scent to a second area from the first area by shooting a scented projectile thereto.

11. The scent distribution method of claim 10, wherein the scent is distributed to the second area from the first area by shooting the scented projectile thereto with a gun disposed in the first area.

12. The scent distribution method of claim 10, further comprising the step of hunting from the first area.

13. The scent distribution method of claim 10, further comprising the steps of:
distributing the scent to a third area from the first area; and
distributing the scent to a fourth area from the first area.

14. The scent distribution method of claim 13, wherein an area between the first area, the second area, the third area, and the fourth area comprises a substantially conical shape, wherein the first area is an apex.

15. The scent distribution method of claim 13, further comprising the step of distributing the scent to a fifth area.

16. The scent distribution method of claim 13, further comprising the steps of:
redistributing the scent to a second area;
redistributing the scent to a third area; and
redistributing the scent to a fourth area.

17. A scent distribution system for distributing lure, comprising:
a gun, configured to shoot, disposed in a first area, and including:
a barrel portion, having a chamber disposed therein; and
a handle portion, coupled to the barrel portion and extending substantially orthogonal therefrom; and
a first projectile including luring scent, configured to lure prey, disposed in a second area, and removably coupleable to the chamber of the barrel portion.

18. The scent distribution system of claim 17, further comprising a second projectile including a luring scent, configured to lure prey, disposed in a third area, and removably coupleable to the chamber of the barrel portion.

19. The scent distribution system of claim 18, wherein the first and second projectiles each comprise an absorbent portion.

20. The scent distribution system of claim 19, wherein the first and second projectiles each comprise a cotton swab.
